(19) United States
(12) Patent Application Publication
(10) Pub. No.: US 2008/0241779 A1
(43) Pub. Date: Oct. 2, 2008

(54) Continuous-atmosphere high-temperature furnace apparatus, method of continuous production of nanocarbon, and method of burning and graphitizing nano-material

(75) Inventors: Takao Kamiyama, Hiratsuka-shi (JP); Guochun Xu, Hiratsuka-shi (JP); Kazuki Shimizu, Hiratsuka-shi (JP)

Correspondence Address: BRUCE L. ADAMS, ESQ.;ADAMS & WILKS, SUITE 1231, 17 BATTERY PLACE, NEW YORK, NY, 10004, US

(73) Assignee: SHONAN GOSEI-JUSHI SEISAKUSHO K.K.

(21) Appl. No.: 12/079,493

(22) Filed: Mar. 27, 2008

(30) Foreign Application Priority Data
Mar. 29, 2007 (JP) 2007-087232

(51) Int. Cl. F27D 7/00; F27B 9/04

(52) U.S. Cl. 432/19; 432/152

(57) ABSTRACT

A continuous-atmosphere high-temperature furnace apparatus comprises a high-temperature furnace section, a mechanism for continuously supplying substrates or samples to the high-temperature furnace section, and a mechanism for continuously discharging treated substrates or samples from the high-temperature furnace section. Gas is exhausted from the high-temperature furnace section and ambient gas is supplied thereto for reaction to produce carbon materials and various other nanomaterials or to burn and graphitize the nanomaterials. The substrates or samples are sequentially moved for heat treatment, thereby improving the work efficiency of the high-temperature furnace.

### BACKGROUND OF THE INVENTION

1. Field of the Invention

The present invention relates to a continuous-atmosphere high-temperature furnace apparatus comprising a mechanism for continuously feeding substrates or samples to a tubular high-temperature furnace, a mechanism for continuously discharging treated substrates or samples, and a supply and exhaust port of ambient gas; to a method of continuous production of nanocarbon and various other nanomaterials using the high-temperature furnace apparatus; and to a method of burning and graphitizing nanomaterials in which nanocarbon or various other nanomaterials are heated using the high-temperature furnace apparatus.

2. Description of the Prior Art

Known high-temperature furnaces include batch-type isothermal boxes, muffle furnaces, ceramic tube furnaces, continuous rotation kilns, and conveyor burning furnaces. In a batch-type high-temperature furnace, a single cycle entails increasing the burning temperature, holding the temperature at a predetermined level, and cooling the furnace to room temperature. This is known to be inefficient because of the time required for raising and lowering the temperature. On the other hand, there is a problem in the heat-resistance and air-tightness of the sliding areas in a continuous high-temperature furnace, and such a furnace is not suitable for controlling the atmosphere and for use in ultrahigh-temperature ranges.

An object of the present invention is to provide a continuous-atmosphere high-temperature furnace apparatus that can control the atmosphere and perform continuous treatment, a method of continuous production of carbon materials using the apparatus, and a method of burning and graphitizing the carbon materials.

### SUMMARY OF THE INVENTION

A continuous-atmosphere high-temperature furnace apparatus according to the present invention comprises a high-temperature furnace section including a high-temperature furnace and a heat-resistant tube that passes through the high-temperature furnace; a delivery section that is disposed at one end of the high-temperature furnace section to deliver an object to be heated to an entrance of the high-temperature furnace section;.an insertion section for inserting the object delivered at the entrance of the high-temperature furnace section into the high-temperature furnace section; a discharge section that is disposed at the other end of the high-temperature furnace section to discharge the object that has been heat-treated in the high-temperature furnace section; a gas supply section provided at the discharge section for supplying ambient gas to the high-temperature furnace section; a gas exhausting section provided at the delivery section to exhaust gas from the high-temperature furnace section; and an interlocking mechanism that operates the delivery and discharge sections in coordination, wherein the delivery and discharge sections are intermittently operated in coordination so as to sequentially and intermittently introduce the object to be heated in the high-temperature furnace section for heat treatment and discharge the treated object from the high-temperature furnace section.

In the present invention, a mechanism for continuously supplying substrates or samples is disposed at one end of a tubular high-temperature furnace, and a mechanism for continuously collecting the substrates or samples after treatment is disposed at the other end thereof. A port for supplying ambient gas into the high-temperature furnace section is provided to the collection section, and a port for exhausting gas from the high-temperature furnace section is provided to the supply section. A series of steps, i.e., heating, heat treatment, and cooling, is carried out as substrates or samples are sequentially moved, whereby the work efficiency of a high-temperature furnace can be increased. The mechanisms for delivering and discharging samples do not make contact with high-temperature areas, and the temperature of the high-temperature furnace is not limited by the heat resistance of sliding parts. Also, a supply box that accommodates the supply mechanism and a collection box that accommodates the collection mechanism are connected to the furnace core tube, an airtight space is formed, air is removed by vacuuming, and ambient gas is easily removed.

Chemical vapor deposition (CVD) apparatus can be obtained by continuously supplying reactive gas while catalyst-carrying substrates are sequentially moved to high-temperature areas using the continuous-atmosphere high-temperature furnace apparatus of the present invention.

Burning, sintering, and graphitization of carbon material or the like are made possible by continuously supplying various ambient gases while crucibles containing produced carbon materials or the like are sequentially moved to high-temperature areas.

In the present invention, objects can be continuously heated by providing delivery and discharge mechanisms, an insertion mechanism, and gas supply and exhaust sections at the ends of the high-temperature furnace section. Considerable commercial and industrial advantages can be obtained in that heating and cooling time can be reduced and work efficiency can be dramatically improved in comparison with a batch-type high-temperature furnace.

The continuous-atmosphere high-temperature furnace of the present invention is also advantageous for research and development because the continuous-atmosphere high-temperature furnace makes it possible to manufacture nanocarbon as a continuous CVD apparatus and to burn and graphitize the nanocarbon thus produced.

Further features of the invention, its nature and various advantages will be more apparent from the accompanying drawings and following detailed description of the invention.

### BRIEF DESCRIPTION OF THE DRAWINGS

FIG. 1 is a schematic block diagram showing a continuous-atmosphere high-temperature furnace apparatus according to the present invention;

FIG. 2 is an electron micrograph (SEM) of a carbon nanocoil (CNC) produced in Embodiment 1 in the invention; and

FIG. 3 is a table showing the volume resistivity of as-grown nanocarbon, burned nanocarbon produced in Embodiment 2, and graphitized nanocarbon produced in Embodiment 3.

### DESCRIPTION OF THE PREFERRED EMBODIMENTS

Preferred embodiments of the present invention will be described hereinafter with reference to the attached drawings. The present invention can be modified in a variety of other forms, and the examples shown herein are provided for describing the present invention. The scope of the present invention is not to be interpreted as being limited by the embodiments described below. The shape and the like of the elements in the drawings are magnified in order to provide a description that is more readily apparent, and should not be interpreted as setting a limit to the technical specification and dimensions of the elements of the present invention.

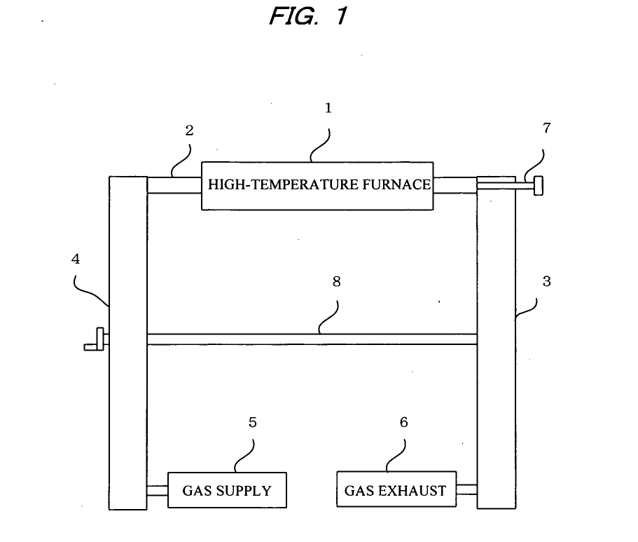

FIG. 1 is a schematic diagram showing a continuous-atmosphere high-temperature furnace apparatus according to the invention. In the apparatus, a delivery mechanism 3 is connected at one end of a tube-shaped high-temperature furnace including a high-temperature furnace 1 and a heat-resistant tube 2 that passes through the high-temperature furnace 1. A discharge mechanism 4 is connected at the other end of the tube-shaped high-temperature furnace. The discharge mechanism 4 is provided with an ambient gas supply section 5, and the delivery mechanism 3 is provided with a gas exhaust section 6.

An insertion mechanism 7 is provided for inserting into the heat-resistant tube 2 substrates or crucibles transported at the entrance thereof by the delivery mechanism 3. An interlocking mechanism 8 that causes the delivery mechanism 3 and discharge mechanism 4 to operate in coordination is also provided.

The high-temperature furnace 1 serves as a heat source and can be selected from a resistance furnace, an infrared furnace, a high-frequency furnace, or the like. The material, shape, and size of the furnace 1 are not particularly limited, but a furnace that has high heat resistance and is fitted to the heat-resistant tube 2 is preferred.

The heat-resistant tube 2 acts to transmit heat from the high-temperature furnace 1 with good efficiency to substrates or samples, and acts to prevent the substrates or samples from being exposed to atmosphere. The tube can therefore be selected from a metal tube, a quartz tube, and a ceramic tube. It is ordinarily preferred that the heat-resistant tube 2 be cylindrical, but other advantageous shapes include square, rectangular, elliptical, and other irregular shapes in cross section.

The delivery mechanism 3 serves to transport substrates or samples to the entrance of the heat-resistant tube 2, and may be selected from a belt conveyor, a roller conveyor, a chain conveyor, a pressure lift, and the like.

The insertion mechanism 7 acts so that substrates or samples that have been transported by the delivery mechanism 3 are moved into the heat-resistant tube 2, is capable of forward/rearward movement, and is configured so as to prevent gas leakage. A sliding rod provided with a vacuum packing, or a threaded bar is advantageous.

The discharge mechanism 4 serves to transport substrates or samples that have been withdrawn from the exit of the heat-resistant tube 2, and may be selected from a belt conveyor, a roller conveyor, a chain conveyor, a pressure lift, and the like in the same manner as the delivery mechanism 3.

The interlocking mechanism 8 is provided so that the delivery mechanism 3 and the discharge mechanism 4 are caused to move at the same pitch. The interlocking mechanism 8 may be selected from a coaxial gear, a coaxial drive roller, and the like in accordance with the delivery mechanism 3 and the discharge mechanism 4. The interlocking mechanism 8 can be manually driven or driven by a stepping motor.

Although not depicted, the substrates or crucibles are preferably composed of heat resistant quartz, carbon material, or ceramic material. The shape and dimensions of the substrate and crucible are not limited, but preferably are those that fit well without damaging the heat-resistant tube 2.

The ambient gas supply section 5 supplies ambient gas to the heat-resistant tube 2 and is disposed at the end portion of the discharge mechanism 4, i.e., in the vicinity of the collection section for collecting substrates or crucibles that have been discharged. The ambient gas supply section 5 is provided with a regulator for controlling the pressure of the ambient gas, and a flow rate meter and valve for monitoring and controlling the gas flow rate. The type of gas is not limited, but hydrogen or another reducing gas; argon, helium, nitrogen or another inert gas; or hydrocarbon or another reactive gas may be selected depending on the application. A liquid hydrocarbon may be vaporized in a reaction gas and used as a supply gas.

The gas exhaust section 6 is disposed in the vicinity of the supply section of the substrates or crucibles of the delivery mechanism 3 and is provided with a vacuum pump and an apparatus for deodorizing exhaust gas. The air inside the apparatus is suctioned out by forming a vacuum, and can be prevented from becoming mixed with the ambient gas that is introduced from the ambient gas supply section 5. The deodorizing apparatus may be selected based on the components of the exhaust gas, but a hydrocarbon-adsorbing activated carbon filter, an alkaline-water scrubber, or the like is preferred.

The catalyst is composed of a metal, a metal compound, a mixture thereof, or an alloy. Among these, the catalyst is preferably selected from the group consisting of metals, alloys, metal compounds, and mixtures containing at least one metal selected from the group consisting of Fe, Co, Ni, Cu, Zn, and other transition metals.

To produce a greater variety of types of nanocarbon at a lower temperature, it is preferred that a substance be added to the catalyst precursor. The substance is selected from the group consisting of simple substances, compounds, or mixtures containing at least one type of substance selected from the group consisting of Al, In, Sn, P, S, and other low-melting metals and nonmetals.

The reactive gas is preferably at least one type of compound selected from the group consisting of hydrocarbon compounds. Preferred are methane, acetylene, or the like, which are gases at room temperature; or gases obtained by vaporizing benzene, toluene, cyclohexane, or the like, or the mixtures gasoline, diesel, kerosene, or the like, which are liquids at room temperature.

Next, the present invention will be described in detail based on Embodiments.

### Embodiment 1

In Embodiment 1, the delivery mechanism 3 and discharge mechanism 4 are arranged as horizontally disposed belt conveyors in the same manner as the schematic diagram shown in FIG. 1. The belt conveyors are intermittently moved using a stepping motor. The insertion mechanism 7 uses a sliding rod mounted in a Wilson seal.

A mixture of iron and tin powders as a catalyst was uniformly coated onto a silicon substrate, the substrate was secured facing upward in a graphite crucible, and the crucible was placed on the conveyor of the delivery mechanism 3 from the high-temperature area.

A vacuum was formed by a vacuum pump of the gas exhaust section 6 to exhaust air from the heat-resistant tube 2, and nitrogen gas was introduced via the gas supply section 5 to the heat-resistant tube 2. These steps were carried out twice and ventilation was performed. A vacuum was formed by the vacuum pump of the gas exhaust section 6 to exhaust the nitrogen gas from the heat-resistant tube 2, and helium gas was introduced via the gas supply section 5 to the heat-resistant tube 2.

While helium gas was introduced via the gas supply section 5, the temperature of the high-temperature furnace 1 was increased to 750° C., and a temperature control apparatus provided to the high-temperature furnace 1 was used to automatically maintain this temperature.

Acetylene was admixed to the helium gas in a fixed ratio via the gas supply section 5 while being introduced into the heat-resistant tube 2.

In this state, a nanocarbon-generating reaction was carried out for 5 minutes in the heat-resistant tube 2. The sliding rod provided to the insertion mechanism 7 was then pushed to move the substrate from the heat-resistant tube 2.

The belt conveyors constituting the delivery and discharge mechanisms 3 and 4 were operated in synchronization to discharge the treated substrate and to deliver the next substrate to the entrance of the heat-resistant tube 2 for insertion thereinto by the sliding rod provided to the insertion mechanism 7.

The movement of the substrates inside the heat-resistant tube 2 by the sliding rod, and the movement thereof by the delivery and discharge mechanisms were repeatedly carried out every 5 minutes. As viewed overall, the substrates are moved intermittently and processed to produce nanocarbon in the heat-resistant tube 2 in a continuous manner.

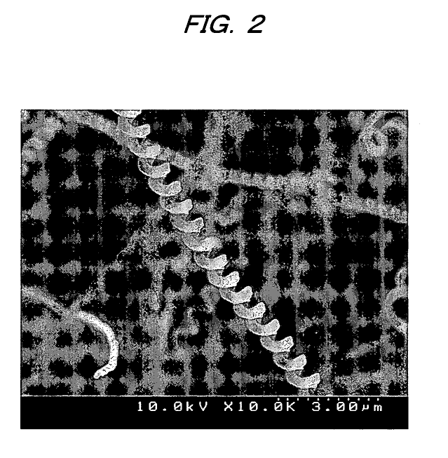

The surfaces of the treated substrates were observed by electron microscope (SEM), and it was apparent that the surfaces were covered by carbon nanocoils (CNC), as shown in FIG. 2.

### Embodiment 2

The apparatus used in Embodiment 2 was the same as in the schematic diagram shown in FIG. 1. However, the delivery mechanism 3 and discharge mechanism 4 were vertically disposed lift conveyors. The lift conveyors were intermittently moved using a stepping motor. The insertion mechanism 7 used a sliding rod mounted in a Wilson seal.

Nanocarbon produced by chemical vapor deposition (CVD) process was placed in a graphite crucible, and the crucible was placed on the conveyor of the delivery mechanism 3 from the high-temperature area.

A vacuum was formed by a vacuum pump of the gas exhaust section 6 to exhaust air from the heat-resistant tube 2, and nitrogen gas was introduced via the gas supply section 5 to the heat-resistant tube 2. These steps were carried out twice and ventilation was performed. A vacuum was formed by the vacuum pump of the gas exhaust section 6 to exhaust the nitrogen gas from the heat-resistant tube 2, and argon gas was introduced via the gas supply section 5 to the heat-resistant tube 2.

While argon gas was introduced via the gas supply section 5, the temperature of the high-temperature furnace 1 was increased to 650° C., and the temperature control apparatus provided to the high-temperature furnace 1 was used to automatically maintain this temperature.

In this state, the nanocarbon in the crucible was heated for 20 minutes in the heat-resistant tube 2. The sliding rod provided to the insertion mechanism 7 was then pushed to move the crucible from the heat-resistant tube 2.

The lift conveyors constituting the delivery and discharge mechanisms 3 and 4 were operated to discharge the burned nonocarbon and deliver the next nanocarbon to the entrance of the heat-resistant tube 2 for insertion thereinto by the sliding rod provided to the insertion mechanism 7.

The movement of the crucibles inside the heat-resistant tube 2 by the sliding rod and the movement thereof by the delivery and discharge mechanisms were repeatedly carried out every 30 minutes. As viewed overall, the nanocarbons were moved intermittently and burned in the heat-resistant tube 2 in a continuous manner.

### Embodiment 3

The same apparatus as in Embodiment 2 was used in Embodiment 3.

Nanocarbon produced in the manner described above was placed in a graphite crucible, and the crucible was placed on the conveyor of the delivery mechanism 3 from the high-temperature area.

A vacuum was formed by a vacuum pump of the gas exhaust section 6 to exhaust air from the heat-resistant tube 2, and nitrogen gas was introduced via the gas supply section 5 to the heat-resistant tube 2. These steps were carried out twice and ventilation was performed. A vacuum was formed by the vacuum pump of the gas exhaust section 6 to exhaust the nitrogen gas from the heat-resistant tube 2, and argon gas was introduced via the gas supply section 5 to the heat-resistant tube 2.

While argon gas was introduced via the gas supply section 5, the temperature of the heat-resistant tube 2 was increased to 2800° C., and the temperature control apparatus provided to the high-temperature furnace 1 was used to automatically maintain this temperature.

In this state, the nanocarbon was burned for 30 minutes. The sliding rod provided to the insertion mechanism 7 was then pushed to move the nanocarbon from the heat-resistant tube 2.

The lift conveyors constituting the delivery and discharge mechanisms 3 and 4 were operated in synchronization to discharge the burned nanocarbon and deliver the next nanocarbon to the entrance of the heat-resistant tube 2 for insertion thereinto by the sliding rod provided to the insertion mechanism 7.

The movement of the nanocarbon inside the heat-resistant tube 2 by the sliding rod and the movement thereof by the delivery and discharge mechanisms were repeatedly carried out every 30 minutes. As viewed overall, the nanocarbons were moved intermittently and graphitized in the heat-resistant tube 2 in a continuous manner.

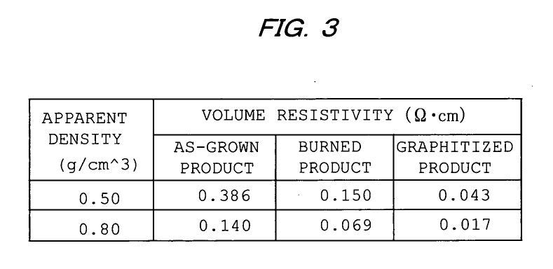

FIG. 3 is a table showing the volume resistivity of as-grown nanocarbon produced by fluid chemical vapor deposition (CVD), burned nanocarbon in Embodiment 2, and graphitized nanocarbon in Embodiment 3. It is apparent that the volume resistivity of the nanocarbon is reduced by burning and graphitization, thereby improving electroconductivity.

What is claimed is:

1. A continuous-atmosphere high-temperature furnace apparatus comprising:
a high-temperature furnace section including a high-temperature furnace and a heat-resistant tube that passes through the high-temperature furnace;
a delivery section that is disposed at one end of the high-temperature furnace section to deliver an object to be heated to an entrance of the high-temperature furnace section;
an insertion section for inserting the object delivered at the entrance of the high-temperature furnace section into the high-temperature furnace section;
a discharge section that is disposed at the other end of the high-temperature furnace section to discharge the object that has been heat-treated in the high-temperature furnace section;
a gas supply section provided at the discharge section for supplying ambient gas to the high-temperature furnace section;
a gas exhausting section provided at the delivery section to exhaust gas from the high-temperature furnace section; and
an interlocking mechanism that operates the delivery and discharge sections in coordination;
wherein the delivery and discharge sections are intermittently operated in coordination so as to sequentially and intermittently introduce the object to be heated in the high-temperature furnace section for heat treatment and discharge the treated object from the high-temperature furnace section.

2. A method of continuously producing nanocarbon by using the continuous-atmosphere high-temperature furnace apparatus according to claim 1, comprising the steps of:
introducing a catalyst-carrying substrate into the high-temperature furnace section;
exhausting air from the high-temperature furnace section;
supplying ambient gas to the high-temperature furnace section;
raising the temperature of the high-temperature furnace section;
introducing a reactive gas to the high-temperature furnace section;
intermittently delivering and discharging the catalyst-carrying substrate to continuously produce a nanocarbon-containing nanomaterial.

3. A method of burning and graphitizing a nanomaterial by using the continuous-atmosphere high-temperature furnace apparatus according to claim 1, comprising the steps of:
introducing crucibles charged with the nanomaterial into the high-temperature furnace section;
exhausting air from the high-temperature furnace section;
supplying ambient gas to the high-temperature furnace section;
raising the temperature of the high-temperature furnace section;
introducing an inert gas to the high-temperature furnace section;
intermittently delivering and discharging the crucible to heat the nanocarbon-containing nanomaterial.

4. A method of continuously producing nanocarbon according to claim 2, wherein the reactive gas is a single compound or a mixture of compounds selected from the group consisting of hydrocarbon compounds.

5. A method of continuously producing nanocarbon according to claim 2, wherein the catalyst is selected from the group consisting of metals, alloys, metal compounds, and mixtures containing at least one metal selected from the group consisting of Fe, Co, Ni, Cu, Zn, and other transition metals.
